(19) United States
(12) Patent Application Publication
(10) Pub. No.: US 2026/0188847 A1
(43) Pub. Date: Jul. 2, 2026

(54) PROTECTIVE FILMS AND METHODS FOR USING SAME

(71) Applicant: Lawrence Livermore National Security, LLC, Livermore, CA (US)

(72) Inventors: Erika Paola RAMOS GUZMAN, Livermore, CA (US); Diego Ignacio OYARZUN DINAMARCA, Livermore, CA (US)

(73) Assignee: Lawrence Livermore National Security, LLC, Livermore, CA (US)

(21) Appl. No.: 19/002,579

(22) Filed: Dec. 26, 2024

(51) Int. Cl. H01M 50/48; H01M 10/0562

(52) U.S. Cl. CPC H01M 50/48; H01M 10/0562; H01M 2300/0068

(57) ABSTRACT

Disclosed herein are artificial solid electrolyte interphase (ASEI) or protective film compositions that include: one or more polymers, where the one or more polymers are selected from polyvinylidene fluoride (PVDF), poly(vinylidene fluoride-co-hexafluoropropylene) (PVDF-HFP), polyaniline (PAN), PEG-based polymers, poly(ethylene glycol) methyl ether acrylate polymers, poly(ethylene oxide) (PEO), and poly(ethylene glycol) methyl ether acrylate; one or more inorganic lithium salts, where the one or more inorganic lithium salts are selected from LiTFSI, LiFSI, LiClO₄, LiF, and LiNO₃; one or more initiators, where the initiators are selected from photo initiators, thermal initiators, and mixtures thereof; one or more particles, where the one or more particles are selected from Li_{6.4}La₃Zr_{1.4}Ta_{0.6}O₁₂ and Li_{6.4+x}AₓLa₃Zr₁₆O₁₂, where A is selected from Ga, Al, and Fe, and where x is a real number from 0 to 1; and one or more additives.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND

### Field

Provided herein are protective films that include polymers, inorganic lithium salts, and micro- and/or nano-sized particles, which can be used for current collectors and anode electrodes for different battery chemistries.

### Description of the Related Art

Commercial lithium-ion (Li-ion) batteries based on graphite anodes are becoming limited by their energy densities. In order to satisfy the large market demands for smaller and lighter rechargeable batteries, high-capacity metallic lithium is replacing low-specific-capacity graphite, enabling higher energy density for the next-generation rechargeable Li metal batteries (LMBs) or all-solid state batteries (ASSBs) with Li metal as the anode. However, using Li metal anodes can have drawbacks. For example, Li metal anodes can suffer from dendrite formation problems, interfacial side reactions with liquid or solid electrolytes, volume changes, and low coulombic efficiency when used as an anode in different cell configurations. The reactive Li metal chemistry makes it challenging to serve as an anode in LMB and/or ASSBs. To overcome these challenges, a uniform Li deposition during Li plating and stripping to protect lithium metal from Li dendrite formation has been tried. Current methods to improve the performance of batteries using Li metal as an anode include: formation of ion conductor layer (formed in situ), electron conductor layer on Li metal anode, design of Li hosts (3D current collectors), modification of electrolyte, binder design, and modification of separator in the case of cells using liquid electrolyte. Besides the in-situ formation of solid electrolyte interphase (SEI) layers induced by solvents, salts, or additives in liquid electrolytes in the case of LIBs, the construction of artificial protective layers before assembling cells is very effective for LIBs and ASSBs. Atomic-layer deposition (ALD) and molecular-layer deposition (MLD) are also important methods in the preparation of artificial protective layers; however, these approaches can be difficult to scale up. Lithium-metal anodes are the most promising anode materials with a tenfold higher theoretical capacity than graphite based anodes. They are also lightweight and have the lowest anode potential of all known electrode materials. However, safety and performance issues associated with an unstable interface and lithium dendrite formation must be overcome for lithium-metal battery technologies to be commercially viable as mentioned before. Moreover, a newly emerging concept of anode-free Li metal and anode-free solid-state batteries are promising for next-generation energy storage systems, especially the mobile sectors, due to their enhanced energy density, improved safety, and extended calendar life.

In addition, anode-free solid state batteries (or lithium-metal-free) batteries, are considered a promising path in the development of safe and high-energy-density batteries. However, their practical implementation has been hindered by the internal strain that arises from the repeated plating and stripping of lithium metal at the interlayer between the solid electrolyte and negative electrode, Some reported studies show that a high current collector/solid electrolyte interface resistance and spatial change at that interface during Li deposition leads to cell degradation. Silver nanoparticles as part of an Ag—C composite layer cast onto a current collector has been reported to promote uniform Li deposition; however, the high resistance of the composite layer led to poor cell performance. The inefficiency of lithium plating and stripping leads to rapid capacity degradation due to the absence of excess lithium inventory.

Different strategies have been used to stabilize the Li metal/electrolyte interface: in-situ formation of an ion conductor layer, deposition of an electron conductor layer on Li metal anode, design of Li hosts (3D current collector), and modification of the electrolyte. For ex-situ approaches such as atomic layer deposition (ALD) and sputtering there have been reports showing the formation of artificial solid electrolyte interphases. However, the ALD and sputtering approaches used to develop an artificial solid electrolyte interphase are associated with high cost and high complexity The in-situ formation of a protective layer while the cell is being cycled improves the electrochemical performance for a rather low number of cycles (hundreds); however, for a cell to be practical it needs to run for >1000 cycles.

Consequently, there is a need for new protective film compositions, which can provide stable interfaces and inhibit lithium dendrite formation for battery applications.

### SUMMARY

Protective film compositions, which can be used in battery applications, are described. In one specific embodiment, the protective film composition includes: one or more polymers, where the one or more polymers are selected from the group consisting of polyvinylidene fluoride, poly(vinylidene fluoride-co-hexafluoropropylene), polyaniline, PEG-based polymers, poly(ethylene glycol) methyl ether acrylate polymer, and poly(ethylene oxide); one or more inorganic lithium salts, where the one or more inorganic lithium salts are selected from the group consisting of LiTFSI, LiFSI, LiClO₄, LiF, and LiNO₃; one or more initiators, where the one or more initiators are selected from the group consisting of one or more photo initiators, one or more thermal initiators, and mixtures thereof; one or more particles, where the one or more particles are selected from the group consisting of Li_{6.4}La₃Zr_{1.4}Ta_{0.6}O₁₂ and Li_{6.4+x}AₓLa₃Zr₁₆O₁₂, wherein A is selected from the group consisting of Ga, Al, and Fe, and where x is a real number from 0 to 1; and one or more additives. In another specific embodiment, a method of using a protective film composition includes applying a protective film to at least partially coat a substrate. In yet another specific embodiment, a battery cell includes a substrate and a protective film composition.

### BRIEF DESCRIPTION OF THE DRAWINGS

For the purposes of promoting an understanding of the principles of the present disclosure, reference can be now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 shows a graph of conductivity and Young's modulus for varying Li salt content in a protective film composition.

FIG. 2 shows an embodiment of a method of making a protective film composition.

FIG. 3 shows an embodiment of a battery cell configuration that uses a protective film coated on a Li anode.

FIG. 4 shows an embodiment of a battery cell configuration that uses a protective film coated on a copper substrate.

FIG. 5 shows a graph that compares the conductivity of Examples 1-4.

FIG. 6 shows a graph of coulombic efficiency for cycles of plating and striping on a battery configuration with a protective film compared to a battery configuration without a protective film.

FIG. 7 shows an embodiment of a battery cell configuration of LiFePO₄-protective film-Li electrode.

FIG. 8 shows a graph of specific capacity versus voltage for a battery cell configuration of LiFePO₄-protective film-Li electrode.

FIG. 9 shows a graph of specific capacity versus coulombic efficiency for a battery cell configuration of LiFePO₄-protective film-Li electrode.

FIG. 10 shows an embodiment of a battery cell configuration of LiFePO₄-protective film-Cu electrode.

FIG. 11 shows a graph of the interface impedance for a battery cell configuration of LiFePO₄-protective film-Cu electrode.

FIG. 12 shows a graph of specific capacity versus coulombic efficiency for a battery cell configuration of LiFePO₄-protective film-Cu electrode.

FIG. 13 shows a graph of specific capacity versus voltage for a battery cell configuration of LiFePO₄-protective film-Cu electrode.

FIG. 14 shows an embodiment of a battery cell configuration of LiFePO₄-protective film-Li_{6.4}La₃Zr_{1.4}Ta_{0.6}O₁₂.

FIG. 15 shows a graph of specific capacity versus voltage of a battery cell configuration of LiFePO₄-protective film-Li_{6.4}La₃Zr_{1.4}Ta_{0.6}O₁₂.

FIG. 16 shows a graph for a battery cell configuration of LiFePO₄-protective film-Li_{6.4}La₃Zr_{1.4}Ta_{0.6}O₁₂.

FIG. 17 shows a graph of time versus voltage for an embodiment of a Li—Li symmetric cell.

### DETAILED DESCRIPTION

A protective film composition for improving the performance of any battery configuration using Li metal as an anode as well as the performance of anode-free Li-metal batteries or anode-free solid state batteries (SSBs) has been developed. In one or more embodiments, the protective film compositions provide a surprising breakthrough in the applicability of Li metal anodes, can be made using a scalable and low-cost method, are compatible with different electrolytes (liquid and/or solid electrolytes), and demonstrate much improved electrochemical performance compared with bare Li metal (anode) or copper foil (current collector). The protective film can also increase the coulombic efficiency of a battery. Coulombic efficiency can be an important parameter for a long cycle life, representing the ratio of the amount of stripped Li versus that of plated Li in each cycle. A stable value of coulombic efficiency typically represents a stable surface between the electrodes and the electrolyte. In some embodiments, the protective film can achieve cycling over >500 cycles with an averaged coulombic efficiency (CE) over >95% at 0.1 mA/cm². In some embodiments, applying a protective film to a current collector of an anode-free solid-state lithium battery improves its cycle life. In some embodiments, applying a protective film to a Li metal anode of a Li-metal battery improves its cycle life. In some embodiments, the protective film composition as a Li-ion conductor can be used as a solid electrolyte. Overall, the protective film composition can suppress Li-dendrite formation because of its mechanical properties.

The protective film compositions can be used in batteries to provide mechanical stability, smooth Li ion transport, chemical passivation ability, and combinations thereof. For example, the protective film can provide for protection for an anode, such as lithium, and/or a current collector, such as copper. The Li-ion batteries can be composed of a positive electrode (cathode)/negative electrode (anode) and a separator including a liquid electrolyte (or a solid electrolyte that serves as a separator as well in all-solid-state batteries) that acts as an ion-conducting medium between the two electrodes. In some embodiments, the protective film can suppress the side reactions on the Li anode/electrolyte interface, enhancing the cycling stability of different solid-state batteries. In some embodiments, the protective film can homogenize the Li deposition onto the current collector, improving the coulombic efficiency and cyclability of an anode-free solid-state battery.

The protective film can be chemically and electrochemically stable against Li metal (anode), forming an even passivation layer that prevents electrolyte decomposition. In some embodiments, the protective layer can improve in-situ formation of Li metal onto a current collector, improving cycling stability. In some embodiments, the protective film can stabilize the Li metal anode/electrolyte interface, allowing for the utilization of super-ionic conductors (solid electrolytes) that are often not stable when compared to Li metal. In some embodiments, the protective film can allow for solid electrolytes, such as sulfide and halide materials, to be incorporated into all-solid-state batteries. In some embodiments, such as in the case of anode-free solid-state batteries and anode-free Li-metal batteries, the protective layer can be coated onto a copper current collector to improve the Li plating/stripping process. In some embodiments, multifunctional artificial solid electrolyte interfaces (ASEI) or protective film compositions can mitigate these challenges by introducing surface chemistry modifications to the current collector.

The protective film can provide a scalable and low-cost method, which can protect the current collector and can improve battery performance by providing a higher columbic efficiency and cyclability than current collectors that do not have a protective film composition. In some embodiments, due to the electrochemical and mechanical properties of the protective film, it can also be used as a solid electrolyte or catholyte.

In one or more embodiments, the protective film composition can include, but is not limited to: one or more polymers; one or more inorganic lithium salts; one or more particle sizes (from nano to micro range), one or more initiators; and one or more additives. In some embodiments, any one of the listed components may be absent. In some embodiments, the polymer can include a monomer material for polymerization synthesis because of its interfacial compatibility with lithium metal and its superior mechanical properties. In some embodiments, the protective film can include three main components: a PEG-based polymer, an inorganic lithium salt, and a thermal or photo initiator; and these three components can give the precise mechanical and electrical properties, respectively, to prevent Li dendrite growth and improve cycling stability. In some embodiments, the protective film can include a PEG-based polymer, an inorganic lithium salt, an inorganic additive, and a thermal or photo initiator which can give the precise mechanical and electrical properties to improve ionic conductivity, prevent Li dendrite growth and improve cycling stability.

The one or more polymers can include, but is not limited to: one or more polyvinylidene fluoride (PVDF); poly(vinylidene fluoride-co-hexafluoropropylene) (PVDF-HFP); polyaniline (PAN); and PEG-based polymers, including poly(ethylene glycol) methyl ether acrylate polymer and poly(ethylene oxide) (PEO); and combinations thereof. The poly(ethylene glycol) methyl ether acrylate (PEGMEA, Mn 480) polymer can include CAS Number 32171-39-4.

The protective film composition can have a content of the one or more polymers that varies widely. For example, the protective film composition can have a polymer content from a low of about 0.1 wt %, about 1.0 wt %, or about 10 wt %, to a high of about 70.0 wt %, about 80.0 wt %, or about 99.9 wt %. In another example, the protective film composition can have a polymer content of at least 75.0 wt %, at least 80.0 wt %, or at least 90.0 wt %. In another example, the protective film composition can have a polymer content from about 5.0 wt % to about 95.0 wt %, about 10.0 wt % to about 22.0 wt %, about 15.0 wt % to about 25.0 wt %, about 18.0 wt % to about 22.0 wt %, about 20.0 wt % to about 80.0 wt %, about 25.0 wt % to about 75.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, about 70.0 wt % to about 80.0 wt %, about 75.0 wt % to about 85.0 wt %, about 78.0 wt % to about 85.0 wt %, or about 79.0 wt % to about 92.0 wt %. The weight percent of the polymer in the protective film composition can be based on the total weight of the protective film composition; based on the total weight of the one or more polymers, one or more inorganic lithium salts, and one or more initiators; or based on the total weight of the one or more polymers, one or more inorganic lithium salts, one or more particles, one or more initiators, and one or more additives.

The one or more polymers can include a copolymer, a block copolymer, a terpolymer, and mixtures thereof. The polymer can have a weight-average molecular weight (M_{w}) that varies widely. For example, the polymer can have a weight-average molecular weight from a low of about 200 g/mol, about 400 g/mol, or about 1,000 g/mol, to a high of about 800,000 g/mol, about 900,000 g/mol, or about 1,200,000 g/mol to 10,000,000 g/mol. In another example, the polymer can have a weight-average molecular weight that is less than 500 g/mol, less than 1,000 g/mol, or less than 10,000 g/mol. In another example, the polymer can have a weight-average molecular weight from about 200 g/mol to about 500 g/mol, about 460 g/mol to about 500 g/mol, about 500 g/mol to about 1,000 g/mol, about 200 g/mol to about 2,000 g/mol, about 1,000 g/mol to about 7,000 g/mol, about 480,000 g/mol to about 1,100,000 g/mol, or about 1,000,000 g/mol to about 10,000,000 g/mol.

The one or more inorganic lithium salts can include, but are not limited to: lithium nitrate (LiNO₃), lithium fluoride (LiF), lithium bis(fluorosulfonyl)imide (LiFSI), lithium bis(trifluoromethanesulfonyl)imide (LiTFSI), lithium bis(pentafluoroethanesulfonyl)imide (LiBETI), lithium hexafluorophosphate (LiPF₆), lithium perchlorate (LiClO₄), and combinations thereof. The one or more inorganic lithium salts of the protective film can impart desirable properties, such as excellent solid electrolyte interphase (SEI)-forming ability, superior thermal and moisture stability, low cost, and high sustainability. In some embodiments, the inorganic lithium salts can be environmentally friendly.

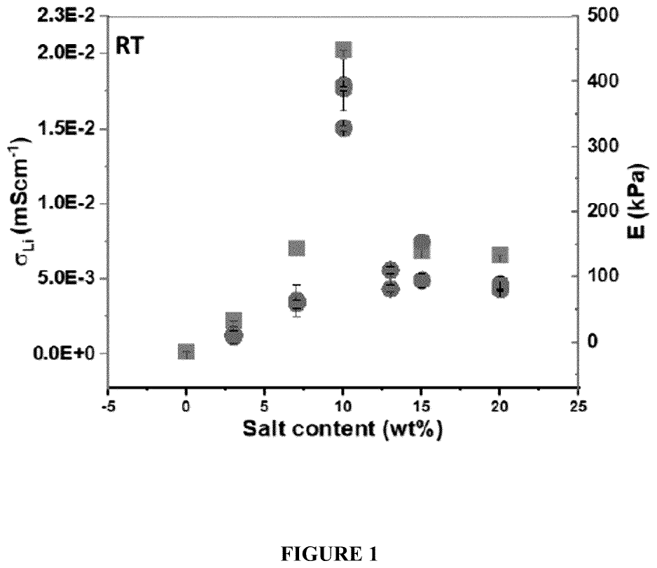

The protective film composition can have a content of the one or more inorganic lithium salts that varies widely. For example, the protective film composition can have an inorganic lithium salt content from a low of about 0.1 wt %, about 1.0 wt %, or about 10 wt %, to a high of about 70.0 wt %, about 80.0 wt %, or about 99.0 wt %. In another example, the protective film composition can have an inorganic lithium salt content of at least 45.0 wt %, at least 50.0 wt %, or at least 55.0 wt %. In another example, the protective film composition can have an inorganic lithium salt content from about 5.0 wt % to about 99.0 wt %, about 3.0 wt % to about 7.0 wt %, about 8.0 wt % to about 22.0 wt %, about 10.0 wt % to about 30.0 wt %, about 15.0 wt % to about 25.0 wt %, about 18.0 wt % to about 22.0 wt %, about 20.0 wt % to about 80.0 wt %, about 25.0 wt % to about 75.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, about 70.0 wt % to about 80.0 wt %, about 75.0 wt % to about 85.0 wt %, about 78.0 wt % to about 85.0 wt %, or about 79.0 wt % to about 92.0 wt %. The weight percent of the inorganic lithium salt in the protective film composition can be based on the total weight of the protective film composition; based on the total weight of the one or more polymers, one or more inorganic lithium salts, and one or more initiators; based on the total weight of the one or more polymers, one or more inorganic lithium salts, one or more particles, one or more initiators, and one or more additives. FIG. 1 shows how the content of the inorganic lithium salt in the protective film composition can affect the conductivity and Young's modulus.

The one or more initiators can include, but are not limited to: one or more photo initiators and one or more thermal initiators. The one or more photo initiators can include, but are not limited to: 2-isopropylthioxanthone (ITX); bis(2,4,6-trimethyl benzoyl)-phenyl phosphine oxide (BAPO); trimethylbenzoyl-diphenylphosphine oxide (TPO); benzophenone; camphorquinone (CQ) and combinations thereof. The one or more thermal initiators can include, but are not limited to: 2,2′-azobis(isobutyronitrile) (AIBN), benzoyl peroxide (BPO), and combinations thereof.

The protective film composition can have a content of the one or more initiators that can varies widely. For example, the protective film composition can have an initiator content from a low of about 0.1 wt %, about 1.0 wt %, or about 10 wt %, to a high of about 70.0 wt %, about 80.0 wt %, or about 99.0 wt %. In another example, the protective film composition can have an initiator content of at least 45.0 wt %, at least 50.0 wt %, or at least 55.0 wt %. In another example, the protective film composition can have an initiator content from about 0.2 wt % to about 2.0 wt %, about 1.0 wt % to about 3.0 wt %, about 5.0 wt % to about 95.0 wt %, about 1.0 wt % to about 3.0 wt %, about 3.0 wt % to about 7.0 wt %, about 25.0 wt % to about 75.0 wt %, about 20.0 wt % to about 80.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. The weight percent of the initiator in the protective film composition can be based on the total weight of the protective film composition; based on the total weight of the one or more polymers, one or more inorganic lithium salts, and one or more initiators; based on the total weight of the one or more polymers, one or more inorganic lithium salts, one or more particles, one or more initiators, and one or more additives.

The one or more particles can include, are not limited to, one or more solid electrolytes. The one or more particles can include, but are not limited to: LLZTO, such as Li_{6.4}La₃Zr_{1.4}Ta_{0.6}O₁₂ and Li_{6.4+x}AₓLa₃Zr₁₆O₁₂, where A is Ga, Al, or Fe, where x is a real number from 0 to 1; and Al₂O₃.

The protective film composition can have a content of the one or more particles that can varies widely. For example, the protective film composition can have a particle content from a low of about 0.1 wt %, about 1.0 wt %, or about 10 wt %, to a high of about 70.0 wt %, about 80.0 wt %, or about 99.0 wt %. In another example, the protective film composition can have a particle content of at least 0.4 wt %, at least 2.0 wt %, or at least 5.0 wt %. In another example, the protective film composition can have a particle content from about 0.2 wt % to about 2.0 wt %, 0.5 wt % to about 1.5 wt %, about 1.0 wt % to about 3.0 wt %, about 3.0 wt % to about 7.0 wt %, about 5.0 wt % to about 95.0 wt %, about 1.0 wt % to about 3.0 wt %, about 25.0 wt % to about 75.0 wt %, about 20.0 wt % to about 80.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. The weight percent of the particle in the protective film composition can be based on the total weight of the protective film composition; based on the total weight of the one or more polymers, one or more inorganic lithium salts, and one or more initiators; or based on the total weight of the one or more polymers, one or more inorganic lithium salts, one or more particles, one or more initiators, and one or more additives.

The one or more particles can have an average diameter that varies widely. For example, the particles can have an average diameter from a low about 50 nm, about 60 nm, or about 80 nm, to a high of about 140 μm, about 150 μm, or about 300 μm. In another example, the particles can have an average diameter from about 60 nm to about 60 microns, 50 nm to about 200 μm, about 50 nm to about 100 nm, about 60 nm to about 500 nm, about 60 nm to about 10 μm, about 65 nm to about 20 μm, about 70 nm to about 110 nm, about 75 nm to about 120 nm, about 80 nm to about 150 nm, about 80 nm to about 150 μm, about 80 nm to about 200 μm, about 100 nm to about 180 μm or about 100 nm to about 300 μm.

The one or more additives an including but are not limited to: fluoroethylene carbonate, one or more electrolyte additives, one or more inorganic fillers, one or more solvents, one or more plasticizers, one or more dispersants, one or more rheology modifiers, one or more inorganic salts, and combinations thereof.

The protective film composition can have a content of the one or more additives that can varies widely. For example, the protective film composition can have an additives content from a low of about 0.1 wt %, about 1.0 wt %, or about 10 wt %, to a high of about 70.0 wt %, about 80.0 wt %, or about 99.0 wt %. In another example, the protective film composition can have an additives content of at least 0.4 wt %, at least 2.0 wt %, or at least 5.0 wt %. In another example, the protective film composition can have an additives content from about 0.2 wt % to about 2.0 wt %, 0.5 wt % to about 1.5 wt %, about 1.0 wt % to about 3.0 wt %, about 5.0 wt % to about 95.0 wt %, about 1.0 wt % to about 3.0 wt %, about 25.0 wt % to about 75.0 wt %, about 20.0 wt % to about 80.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 99.0 wt %. The weight percent of the particle in the protective film composition can be based on the total weight of the protective film composition; based on the total weight of the one or more polymers, one or more inorganic lithium salts, and one or more initiators; based on the total weight of the one or more polymers, one or more inorganic lithium salts, one or more particles, one or more initiators, and one or more additives.

The protective film composition can have a viscosity that varies widely. For example, the protective film composition can have a viscosity from a low of about 0.0074 cP, about 1.0 cP, or about 100,000 cP, to a high of about 250,000 cP, about 900,000 cP, or about 2,500,000 cP. In another example, the protective film composition can have a viscosity from about 0.0074 cP to about 5 cP, about 10 cP to about 200,000 cP, about 100 cP to about 10,000 cP, about 10,000 cP to about 100,000 cP, about 1,000 cP to about 250,000 cP, about 10,000 cP to about 50,000 cP, about 100,000 cP to about 250,000 cP, about 620,000 cP to about 850,000 cP, about 700,000 cP to about 750,000 cP, about 700,000 cP to about 800,000 cP, about 650,000 cP to about 855,000 cP, about 700,000 cP to about 800,000 cP, about 500,000 cP to about 1,000,000 cP, or about 500,000 cP to about 2,500,000 cP. The viscosity of the protective film composition can be measured on a viscosimeter at various temperatures, such as 25° C., 40° C., 60° C., and 100° C.

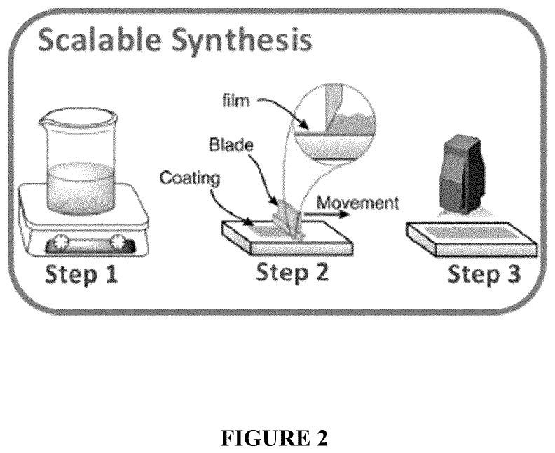

In one or more embodiments, the method of making a protective film composition can include, but is not limited to: adding one or more polymers and one or more inorganic lithium salts to a reaction vessel to make a reaction mixture. In some embodiments, the method of making a protective film composition can include one or more reaction mixtures. In some embodiments, the method of making protective film composition can include adding the one or more additives to the reaction mixture. In some embodiments, the method of making protective film composition can include adding the one or more solid electrolytes to the reaction mixture. In some embodiments, the method of making protective film composition can include adding an initiator to the reaction mixture to make a cured film composition. The method of making a protective film composition can include one or more reaction mixtures. FIG. 2 shows an embodiment of a method of making a protective film composition.

The reaction mixture can be heated to a wide range of temperatures. For example, the reaction mixture can be heated to a temperature from a low of about 0° C., about 15° C., or about 25° C., to a high of about 35° C., about 65° C., or about 200° C. For example, the reaction mixture can be heated to a temperature from about 25° C. to about 28° C., about 25° C. to about 35° C., about 25° C. to about 90° C., about 30° C. to about 45° C., about 40° C. to about 90° C., about 43° C. to about 78° C., about 40° C. to about 90° C., about 100° C. to about 200° C. In another example, the reaction mixture can be at room temperature in air or under argon atmosphere. In another example, the reaction occurs at a temperature of greater than about 40° C. or greater than about 50° C.

The reaction mixture can be reacted and/or stirred for a first reaction time from a short of about 30 s, about 120 s, or about 300 s, to a long of about 1 h, about 24 h, or about 72 h. For example, the reaction mixture can be from about 1 min to about 15 min, about 5 min to about 45 min, about 1 h to about 7 h, about 1 h to about 12 h, about 5 h to about 15 h, about 10 h to about 24 h, about 12 h to about 17 h, about 12 h to about 24 h, about 22 h to about 50 h, or about 24 h to about 72 h.

In one or more embodiments, the method of using a protective film composition can include, but is not limited to: applying a protective film composition to a substrate. The substrate can include, but is not limited to: copper, aluminum, lithium, one or more metals, one or more alloys, common cathode materials, such as NMC, LCO, and LFP, and combinations thereof. In some embodiments, the applying protective film composition can include, but is not limited to: mechanical application, casting, solution casting, spin coating, sputter coating, doctor blade coating, deposition, and combinations thereof.

The protective film can have a thickness that varies widely. For example, the protective film can have a thickness from a low of about nanometer range when nanosized particle are utilized, or 1.0 microns, about 10.0 microns, or 50.0 microns, to a high of about 100.0 microns, about 500.0 microns, or about 2.0 mm. In another example, the protective film can have a thickness from about 1.0 microns to about 2.0 mm, about 2.0 microns to about 20.0 microns, about 5.0 microns to about 50.0 microns, about 10.0 microns to about 100.0 microns, about 20.0 microns to about 250.0 microns, about 30.0 microns to about 500.0 microns, about 300.0 microns to about 900.0 microns, about 100.0 microns to about 1.0 mm, about 200.0 microns to about 1.0 mm, or about 1.0 mm to about 2.0 mm.

The protective film can have an ionic conductivity that varies widely. For example, the protective film can have ionic conductivity from a low of about 0.02 millisiemens per centimeter (mS/cm), about 0.23 mS/cm, or about 0.4 mS/cm at room temperature, to a high of about 0.6 mS/cm, about 0.9 mS/cm, or about 1.1 mS/cm at 60° C. In another example, the protective film can have ionic conductivity from about 0.02 mS/cm to about 0.4 mS/cm, about 0.4 mS/cm to about 1.0 mS/cm, or about 0.8 mS/cm to about 1.5 mS/cm at 60° C.

The protective film can have a Young's modulus that varies widely. For example, the protective film can have Young's modulus from a low of about 0.5 MPa, about 1.75 MPa, or about 2.0 MPa, to a high of about 2.8 MPa, about 3.2 MPa, or about 4.0 MPa. In another example, the protective film can have Young's modulus from about 0.5 MPa to about 4.0 MPa, about 2.0 MPa to about 2.7 MPa, about 2.2 MPa to about 3.0 MPa, about 2.4 MPa to about 3.5 MPa, or about 2.6 MPa to about 3.2 MPa.

In one or more embodiments, the protective film composition can be used in a wide variety of applications. For example, the protective films can be used as a protective film in Li-ion batteries, such as on copper to protect the lithium anodes. In another example, the protective films can be used in anode-free solid state Li batteries as an artificial solid electrolyte interphase. In another example, the protective films can be used as polymer electrolytes, solid polymer electrolytes, composite polymer electrolytes, catholytes, and combinations thereof.

The protective film can be used in a wide variety of battery configurations. For example, the protective film compositions can be used in Li-ion batteries, anode-free batteries, Li-metal batteries, all-solid-state batteries, flow batteries, lithium-oxygen batteries, and combination thereof. In some embodiments, the protective film composition can be applied as a coating to an anode, such as Li, and/or a current collector, such as Cu. In some embodiments, Li-ion batteries can include a positive electrode (cathode)/negative electrode (anode) and a separator including a liquid electrolyte (or a solid electrolyte that serves as a separator as well in all-solid-state batteries) that acts as an ion-conducting medium between the two electrodes. The protective film composition can enable the use of Li metal as an anode, unlocking the hindered applicability of lithium superionic conductors that are unstable against Li metal as mentioned before. For example, the protective film can stabilize the Li metal anode/electrolyte interface, allowing for the use of super-ionic conductors (solid electrolytes) that are not stable versus Li metal. In some embodiments, the protective film can be used to protect a Li anode by at least partially inhibiting electrolyte decomposition and Li dendrite growth.

The protective film composition can also be used in connection with anode free-solid-state battery (AF-SSB) technology. AF-SSB technology can mitigate safety concerns and provide a higher energy density compared to Li-ion and solid-state batteries. For the anode-free configuration, the cell can include a positive electrode (cathode) and electrolyte (liquid or solid) and a current collector and the negative electrode (Li metal) formed in-situ while the cell is cycled. However, two known issues face AF-SSBs, one is achieving a homogeneous Li deposition onto the current collector, and second is the formation of a stable solid electrolyte interface. In some embodiments, the protective film can allow for Li deposition at the film/Cu interface while maintaining its thickness during cycling, indicating its crucial role in both dendrite protection and volume stability in an anode free cell configuration. In some embodiments, the protective film compositions can at least partially protect the current collector and can improve battery performance. In some embodiments, a protective film coating can at least partially protect the Li anode by inhibiting electrolyte decomposition and Li dendrite growth. Due to the electrochemical and mechanical properties of the protective film, it can also be used as a solid electrolyte or catholyte.

The battery cell that includes a protective film composition can have a coulombic efficiency that varies widely. For example, a battery cell with a protective film composition can have a coulombic efficiency from a low of about 60%, to a high of about 80.0%, about 95.0%, or about 99.9%, when compared to a battery cell that does not have the protective file. In another example, a battery cell with a protective film composition can have a coulombic efficiency from a about 60.0% to about 70.0%, about 70.0% to about 80.0%, about 80.0% to about 90.0%, about 95.0% to about 99.0%, or about 90.0% to about 99.9%, when compared to a battery cell that does not have the protective file.

The battery cell that includes a protective film composition can have a current density that varies widely. For example, a battery cell with a protective film composition can have a current density from a low of about 1.0 μA/cm², about 5.0 μA/cm², or about 10.0 μA/cm², to a high of about 0.1 mA/cm², about 0.2 mA/cm², or about 25 mA/cm². In another example, a battery cell with a protective film composition can have a current density from about 0.1 μA/cm² to about 1.0 μA/cm², about 0.1 μA/cm² to about 1.0 mA/cm², about 0.2 μA/cm² to about 0.5 μA/cm², about 0.4 μA/cm² to about 0.8 μA/cm², about 0.5 μA/cm² to about 5.0 μA/cm², or about 0.2 mA/cm² to about 0.5 mA/cm².

### EXAMPLES

To provide a better understanding of the foregoing discussion, the following non-limiting examples are offered. Although the examples can be directed to specific embodiments, they are not to be viewed as limiting the invention in any specific respect.

Four example protective film compositions were made according to Table 1.

TABLE 1
Example Film Compositions

| | | | | | | Initiators | Additives | |
|---|---|---|---|---|---|---|---|---|
| | Polymer | Li salt | | Particles | | (2- | (fluoroethylene | |
| | (PEGMEA) | (LiNO₃) | | (Li_{6.4}La₃Zr_{1.4}Ta_{0.6}O₁₂) | | isopropylthioxanthone) | carbonate) | |
| Ex. 1 | 80.0 wt % | 20.0 | wt % | 0.0 | wt % | 0.0 wt % | 0.0 | wt % |
| Ex. 2 | 85.0 wt % | 15.0 | wt % | 0.0 | wt % | 1.0 wt % | 1.0? | wt % |
| Ex. 3 | 80.0 wt % | 10.0 | wt % | 10.0 | wt % | 1.0 wt % | 3.0 | wt % |
| Ex. 4 | 95.0 wt % | 5.0 | wt % | 5.0 | wt % | 1.0 wt % | 3.0 | wt % |

Example 1 of the protective film composition was made of 80.0 wt % of poly(ethylene glycol) methyl ether acrylate (PEGMEA, Mn 480) polymer and 20.0 wt % of LiNO₃. Examples 2-4 of the protective film compositions further included 5.0 wt % of LLLZTO (Li_{6.4}La₃Zr_{1.4}Ta_{0.6}O₁₂) particles (nano to micro size range) and 1-3 wt % of fluoroethylene carbonate (FEC). All examples had 1.0 wt % of photo initiator, 2-isopropylthioxanthone (ITX). (Other photo initiators, such as bis(2,4,6-trimethyl benzoyl)-phenyl phosphine oxide, were tested).

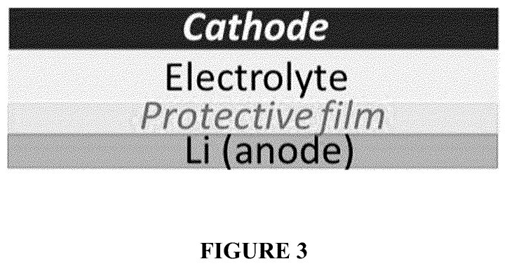

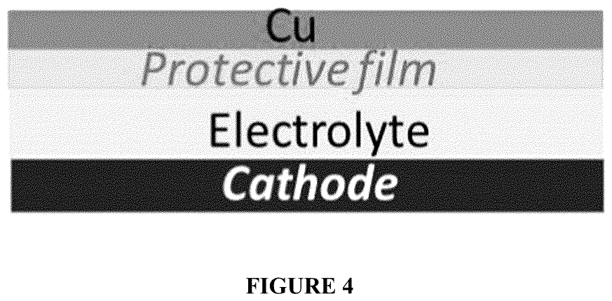

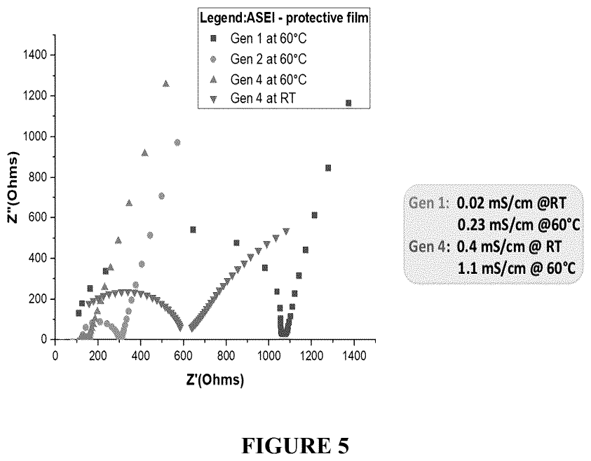

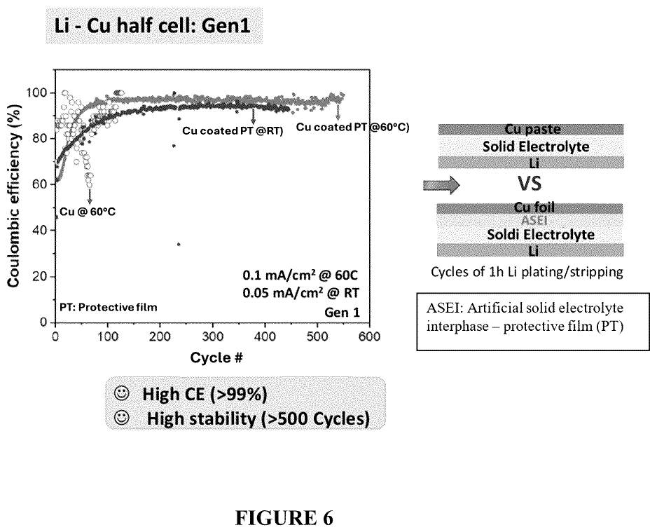

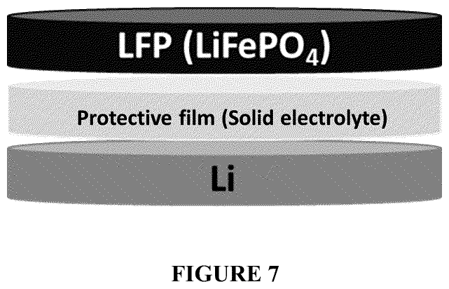

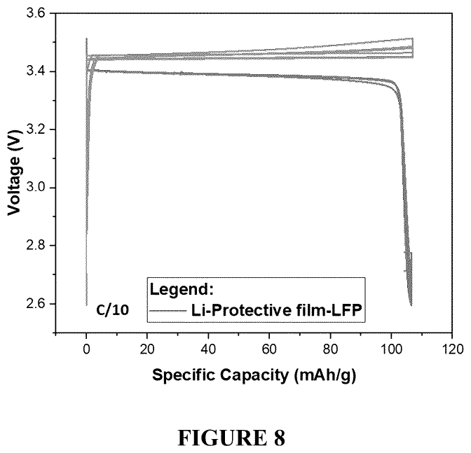

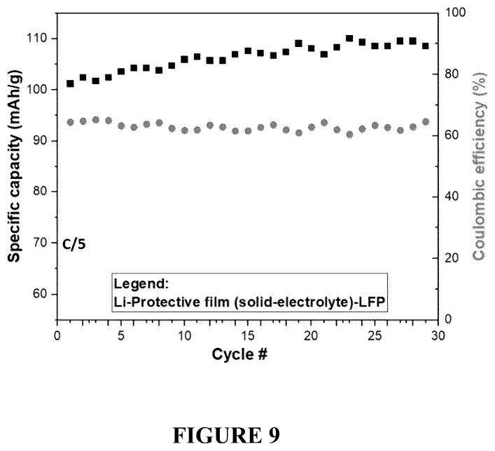

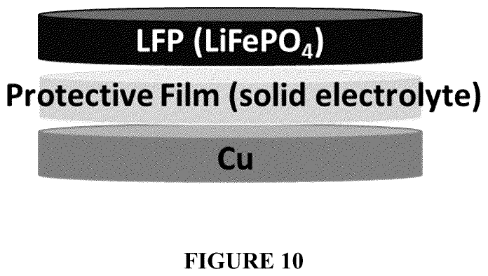

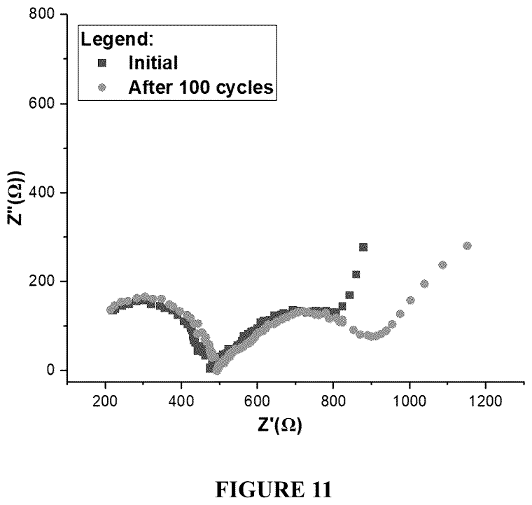

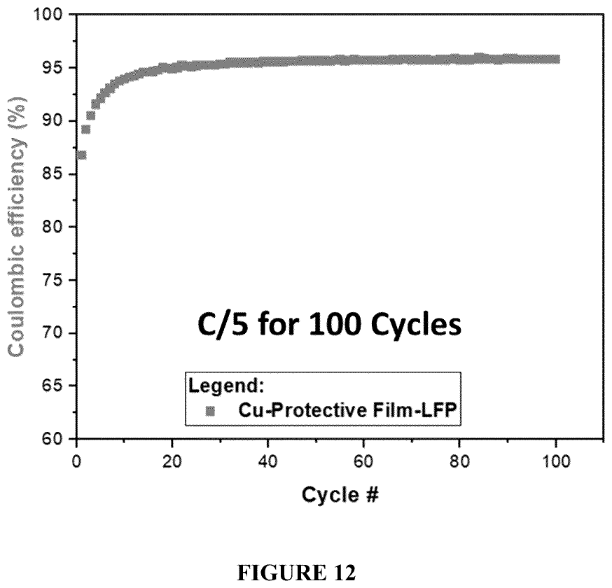

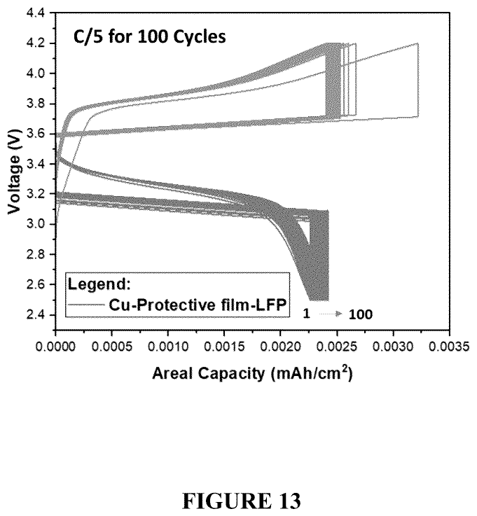

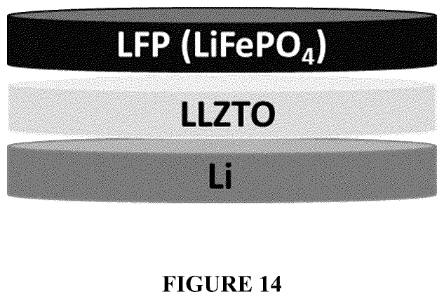

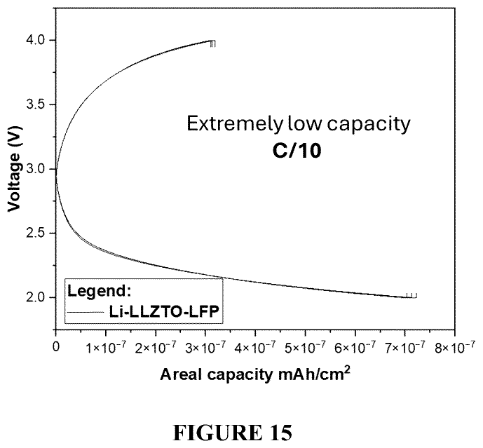

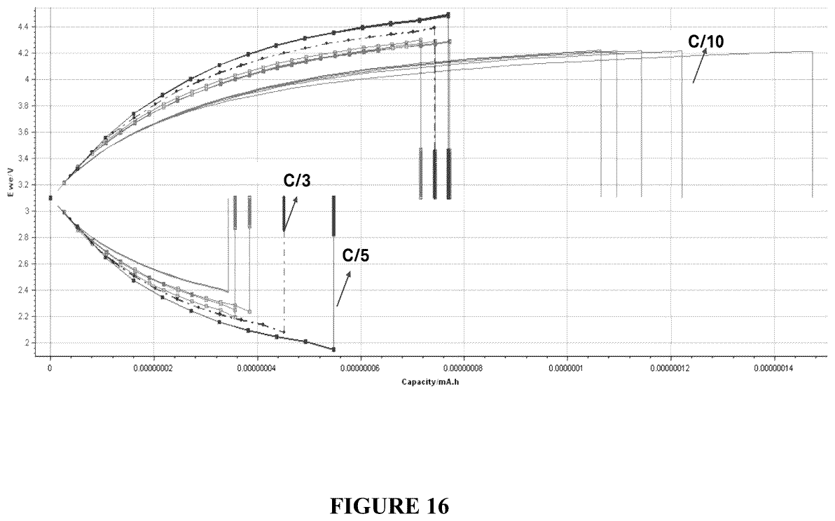

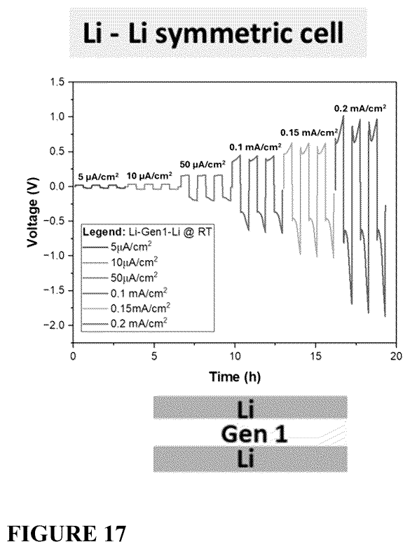

FIGS. 3-17 show the cell configurations and the experimental results for the protective film compositions. The protective films were tested in solid-state Li metal batteries (LFP-Protective film-Li) and anode-free solid-state batteries (LFP-Protective film-Cu). The protective film showed a high and stable coulombic efficiency over 95% even after 500 cycles in the anode free configuration, and a promising specific capacity (>100 mAh/g) in the case of the Li metal battery configuration. The results from both cell configurations—namely the observed small increase in the impedance after >100 cycles in the anode free configuration—show that the protective film forms a stable interface with Li metal and Cu current collector, in accordance with the data presented in the half-cell configuration. The results were obtained with Example 1 of the protective film and before optimizing synthesis protocols such as the casting protocol to decrease the thickness of the film, evidencing the surprising impact of this invention. In contrast, the full cell without the protective film shows a very poor performance even at low C-rates (C/10).

The protective film can be chemically and electrochemically stable against Li metal (anode), forming an even passivation layer that prevents electrolyte decomposition, which is a key challenge in batteries using Li metal as anodes. Moreover, the film can direct Li deposition at the film/Cu interface while maintaining its thickness during cycling, indicating its crucial role in both dendrite protection and volume stability in an anode free cell configuration. Due to the high ionic conductivity of the film (0.4 mS/cm at room temperature (RT), Example 4), it could be used as a solid electrolyte, shows the four different examples with improved conductivity, and shows the platting striping behavior of Example 1 of the protective film compared to without the protective film. Example 1 had a conductivity of 0.02 mS/cm at room temperature and 0.23 mS/cm at 60° C. Example 4 had a conductivity of 0.4 mS/cm at room temperature and 1.1 mS/cm at 60° C. The protective layer ultrahigh ionic conductivity at RT is a surprising and unexpected advancement in batteries.

The protective film compositions can serve as a protective layer for improving the performance of anode-free solid-state batteries. The protective film stabilized the interface between Li metal anode and electrolyte (solid or liquid), improving performance of any battery configuration using Li metal as an anode as well as the performance of anode-free Li-metal batteries or anode-free solid-state batteries. The protective film suppresses Li-dendrite formation due to its mechanical properties. The protective film compositions provided stable cycling over >500 cycles with an averaged coulombic efficiency of over 95% was achieved at 0.1 mA/cm² in a half cell (e.g., Li-protective film+solid electrolyte-Cu).

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits may be the values from the examples. Certain lower limits, upper limits and ranges appear in at least one claims below. All numerical values are “about” or “approximately” the indicated value, and consider experimental error and variations that would be expected by a person having ordinary skill in the art.

What is claimed is:

1. A protective film composition comprising:
one or more polymers, wherein the one or more polymers are selected from the group consisting of polyvinylidene fluoride, poly(vinylidene fluoride-co-hexafluoropropylene), polyaniline, PEG-based polymers, poly(ethylene glycol) methyl ether acrylate polymer, and poly(ethylene oxide); one or more inorganic lithium salts, wherein the one or more inorganic lithium salts are selected from the group consisting of LiTFSI, LiFSI, LiClO₄, LiF, and LiNO₃;
one or more initiators, wherein the one or more initiators are selected from the group consisting of one or more photo initiators, one or more thermal initiators, and mixtures thereof;
one or more particles, wherein the one or more particles are selected from the group consisting of Li_{6.4}La₃Zr_{1.4}Ta_{0.6}O₁₂ and Li_{6.4+x}AₓLa₃Zr₁₆O₁₂, wherein A is selected from the group consisting of Ga, Al, and Fe, and wherein x is a real number from 0 to 1; and
one or more additives.

2. The artificial solid electrolyte interphase or protective film composition of claim 1,
wherein the one or more polymers is poly(ethylene glycol) methyl ether acrylate, wherein the protective film composition has a polymer content from about 70.0 wt % to about 90 wt %, wherein the one or more inorganic lithium salts is LiNO₃, and wherein the protective film composition has an inorganic lithium salt content from about 10.0 wt % to about 30.0 wt %.

3. The protective film composition of claim 1, wherein the one or more polymers is poly(ethylene glycol) methyl ether acrylate, wherein the protective film composition has a polymer content from about 78.0 wt % to about 88.0 wt %, wherein the one or more inorganic lithium salts is LiNO₃, and wherein the protective film composition has an inorganic lithium salt content from about 12.0 wt % to about 22.0 wt %.

4. The protective film composition of claim 1, wherein the one or more initiators comprises 2-isopropylthioxanthone, and wherein the protective film composition has an initiator content from about 0.5 wt % to about 1.5 wt %.

5. The protective film composition of claim 1, wherein the one or more additives comprises fluoroethylene carbonate, and wherein the protective film composition has a fluoroethylene carbonate from about 0.5 wt % to about 5.0 wt %.

6. The protective film composition of claim 1, wherein the one or more particles comprises Li_{6.4}La₃Zr_{1.4}Ta_{0.6}O₁₂, and wherein the protective film composition has a one or more particle content from about 3.0 wt % to about 7.0 wt %

7. The protective film composition of claim 6, wherein the one or more particles has a diameter from about 60 nm to about 10 μm.

8. A method of using a protective film composition comprising:
applying a protective film to at least partially coat a substrate, wherein the protective coating comprises:
one or more polymers, wherein the one or more polymers are selected from the group consisting of polyvinylidene fluoride, poly(vinylidene fluoride-co-hexafluoropropylene) (PVDF-HFP), polyaniline (PAN), PEG-based polymers, poly(ethylene glycol) methyl ether acrylate polymer, and poly(ethylene oxide);
one or more inorganic lithium salts, wherein the one or more inorganic lithium salts are selected from the group consisting of LiTFSI, LiFSI, LiClO₄, LiF, and LiNO₃;
one or more initiators, wherein the one or more initiators are selected from the group consisting of one or more photo initiators, one or more thermal initiators, and mixtures thereof;
one or more particles, wherein the one or more particles are selected from the group consisting of Li_{6.4}La₃Zr_{1.4}Ta_{0.6}O₁₂ and Li_{6.4+x}AₓLa₃Zr₁₆O₁₂, wherein A is selected from the group consisting of Ga, Al, and Fe, and wherein x is a real number from 0 to 1; and
one or more additives.

9. The method of using a protective film composition of claim 8, wherein the one or more polymers is poly(ethylene glycol) methyl ether acrylate, wherein the protective film composition has a polymer content from about 70.0 wt % to about 90 wt %, wherein the one or more inorganic lithium salts is LiNO₃, and wherein the protective film composition has an inorganic lithium salt content from about 10.0 wt % to about 30.0 wt %.

10. The method of using a protective film composition of claim 8, wherein the one or more polymers is poly(ethylene glycol) methyl ether acrylate, wherein the protective film composition has a polymer content from about 78.0 wt % to about 88.0 wt %, wherein the one or more inorganic lithium salts is LiNO₃, and wherein the protective film composition has an inorganic lithium salt content from about 12.0 wt % to about 22.0 wt %.

11. The method of using a protective film composition of claim 8, wherein the one or more initiators comprises 2-isopropylthioxanthone, and wherein the protective film composition has an initiator content from about 0.5 wt % to about 1.5 wt %.

12. The method of using a protective film composition of claim 8, wherein the one or more additives comprises fluoroethylene carbonate, and wherein the protective film composition has a fluoroethylene carbonate from about 0.5 wt % to about 5.0 wt %.

13. The method of using a protective film composition of claim 8, wherein the one or more particles comprises Li_{6.4}La₃Zr_{1.4}Ta_{0.6}O₁₂, and wherein the protective film composition has a one or more particle content from about 3.0 wt % to about 7.0 wt %.

14. The method of using a protective film composition of claim 13, wherein the one or more particles has a diameter from about 60 nm to about 10 μm.

15. A battery cell comprising:
a substrate; and
a protective film composition, wherein the composition comprises:
one or more polymers, wherein the one or more polymers are selected from the group consisting of polyvinylidene fluoride, poly(vinylidene fluoride-co-hexafluoropropylene), polyaniline, PEG-based polymers, poly(ethylene glycol) methyl ether acrylate polymers, and poly(ethylene oxide);
one or more inorganic lithium salts, wherein the one or more inorganic lithium salts are selected from the group consisting of LiTFSI, LiFSI, LiClO₄, LiF, and LiNO₃;
one or more initiators, wherein the one or more initiators selected from the group consisting of one or more photo initiators, one or more thermal initiators, and mixtures thereof;
one or more particles, wherein the one or more particles are selected from the group consisting of Li_{6.4}La₃Zr_{1.4}Ta_{0.6}O₁₂ and Li_{6.4+x}AₓLa₃Zr₁₆O₁₂, wherein A is selected from the group consisting of Ga, Al, and Fe, and wherein x is a real number from 0 to 1; and
one or more additives.

16. The battery cell of claim 15, wherein the one or more polymers is poly(ethylene glycol) methyl ether acrylate, wherein the protective film composition has a polymer content from about 70.0 wt % to about 90 wt %, wherein the one or more inorganic lithium salts is LiNO₃, and wherein the protective film composition has an inorganic lithium salt content from about 10.0 wt % to about 30.0 wt %.

17. The battery cell of claim 15, wherein the one or more polymers is poly(ethylene glycol) methyl ether acrylate, wherein the protective film composition has a polymer content from about 78.0 wt % to about 88.0 wt %, wherein the one or more inorganic lithium salts is LiNO₃, and wherein the protective film composition has an inorganic lithium salt content from about 12.0 wt % to about 22.0 wt %.

18. The battery cell of claim 15, wherein the one or more initiators comprises 2-isopropylthioxanthone, wherein the protective film composition has an initiator content from about 0.5 wt % to about 1.5 wt %, wherein the one or more additives comprises fluoroethylene carbonate, and wherein the protective film composition has a fluoroethylene carbonate from about 0.5 wt % to about 5.0 wt %.

19. The battery cell of claim 15, wherein the one or more particles comprises Li_{6.4}La₃Zr_{1.4}Ta_{0.6}O₁₂, wherein the protective film composition has a one or more particle content from about 3.0 wt % to about 7.0 wt %, and wherein the one or more particles has a diameter from about 60 nm to about 10 μm.

20. The battery cell of claim 15, wherein the battery cell has a current density from about 0.1 μA/cm² to about 2.0 mA/cm².
